(19) United States
(12) Patent Application Publication
(10) Pub. No.: US 2023/0271369 A1
(43) Pub. Date: Aug. 31, 2023

(54) METHOD AND DEVICE FOR PRODUCING FILMS FROM PLASTIC

(71) Applicant: battenfeld-cincinnati germany gmbh, Bad Oeynhausen (DE)

(72) Inventor: Kurt Huth, Bobingen (DE)

(21) Appl. No.: 18/009,739

(22) PCT Filed: Mar. 11, 2021
(86) PCT No.: PCT/EP2021/056205

§ 371 Date: Dec. 12, 2022

(30) Foreign Application Priority Data
Mar. 25, 2020 (DE) 10 2020 108 164.2

(51) Int. Cl. B29C 48/88; B29C 48/92; B29C 48/305; B29C 48/08; B29C 55/18

(52) U.S. Cl. CPC B29C 48/914; B29C 48/92; B29C 48/305; B29C 48/08; B29C 55/18; B29C 2948/92704; B29C 2948/92714; B29C 2948/92923; B29C 2948/92942; B29K 2023/12

(57) ABSTRACT

A film is manufactured from a semi-crystalline plastics material by a method with multiple steps. In step a, the film is shaped using a calender, in which a melt coming from a slotted nozzle is introduced into a nip between two cooling or calibrating rollers. The film is calendered between the two cooling or calibrating rollers. In step b, The film is cooled in a cooling section, which has roller pairs arranged one after the other. A film temperature is changed by changing a temperature of downstream rollers, thereby achieving a maximum number of crystallization nuclei. The film temperature is detected using sensors. In step c, the film is cooled down further to a film temperature that allows the film to be spooled. The temperature of the film is kept in a defined temperature range between 128° C. and 138° C. in step b), thereby preventing the automatic formation of further crystals.

### CROSS REFERENCE TO RELATED APPLICATIONS

This application is a U.S. National Phase application under 35 U.S.C. § 371 of International Application No. PCT/EP2021/056205, filed on Mar. 11, 2021, and claims benefit to German Patent Application No. DE 10 2020 108 164.2, filed on Mar. 25, 2020. The International Application was published in German on Sep. 30, 2021 as WO 2021/190949 A1 under PCT Article 21(2).

### FIELD

The present disclosure relates to a method for manufacturing film, in particular a film made of a semi-crystalline plastics material.

### BACKGROUND

In the current state of the art, polypropylene (PP) semi-finished products (polypropylene films) for the subsequent thermoforming process are manufactured using a three-roller calender or a chill-roll system. In most cases, the biggest focus is efficiency, i.e., a high material throughput, at the lowest possible system costs. This approach results from a lack of knowledge in terms of the required quality in the semi-finished products and their specifications (measurements). However, the ever-increasing material costs of the raw materials to be processed and the essential considerations in terms of environmental impact when more material is used are prompting a rethink. Over the years, the weight of the finished product has been successfully reduced by improving the thermoforming process. Yet, this has now reached its limit and it is no longer possible to make considerable savings when considering only the thermoforming process. There are substantially no more options available for material optimization, e.g., nucleation.

In recent years, more papers have been published indicating that there is still untapped potential in the semi-finished product (film). One significant finding is that the strain in the finished products of the thermoforming process (cups, films, etc.) is dependent on two factors: the uniform wall thickness and the elastic modulus in the finished product.

Over the years, the elastic modulus has been steadily increased by externally (heterogeneously (externally)) nucleating the raw material. This has resulted in a steady increase in crystallinity, not only in the finished product but also in the semi-finished product (film) (40% to 70%).

Film tolerances are some of the key quality features since they have a direct impact on the weight of the finished product and also lead to different heating, which in turn cause differences in wall thickness. By way of example, today's standard in terms of film tolerances for a 1 mm film is +/−0.02 mm=+/−2%.

Stresses in the film are another factor in the manufacture of PP semi-finished products.

Today, devices as known, for example, from EP 1 600 277 A2 or EP 2 670 577 provide the features needed for accomplishing the new findings on the quality of PP films for thermoforming.

For example, EP 0 732 183 A2 describes a device for continuously manufacturing in particular plane-parallel, two-dimensional films, webs, or sheeting of any length using a plastic mass, e.g., a plastics material, that solidifies in the event of a change in temperature. Between the driving and deflecting roll, there is/are provided in each case at least one calibrating roll which can be rotated on the upper or lower belt on the side remote from the mass-forming side, and the mutual spacing between the belts is smaller in the region of the rotatable calibrating rolls than the spacing between the belts, and each driving roll comprises at least one dedicated drive motor.

### SUMMARY

In an embodiment, the present disclosure provides a method for manufacturing a film made of a semi-crystalline plastics material. The method includes: a) shaping the film using a calender in which a melt coming from a slotted nozzle is introduced into a nip between two cooling or calibrating rollers, the film being calendered between the two cooling or calibrating rollers, the film being cooled in a cooling section having roller pairs arranged one after the other; b) changing a film temperature by changing a temperature of downstream rollers, thereby achieving a maximum number of crystallization nuclei, the film temperature being detected using sensors; and c) cooling the film down further to a film temperature that allows the film to be spooled. The temperature of the film is kept in a defined temperature range between 128° C. and 138° C. in step b), thereby preventing the automatic formation of further crystals.

### DETAILED DESCRIPTION

In an embodiment, the present disclosure provides a method for manufacturing polypropylene films in which the quality of the produced semi-finished product (the film) remains largely unchanged and reproducible even over many production cycles, as well as to provide a device for carrying out the method.

The present disclosure, therefore, relates to a method for manufacturing film, in particular a film made of a semi-crystalline plastics material, the method including the following steps: a) shaping the film using a calender in which a melt coming from a slotted nozzle is introduced into the nip between two cooling or calibrating rollers, the film being calendered between the two cooling or calibrating rollers, the film being cooled in a cooling section composed of roller pairs arranged one after the other.

According to an aspect of the present disclosure, a method with the above described advantages is characterized in that step a) is followed by step b) changing the film temperature by changing the temperature of the downstream rollers, the film temperature being detected using sensors, and step c) cooling the film down further to a film temperature that allows the film to be spooled, the temperature of the film being kept in a defined temperature range in step b), thereby preventing the automatic formation of further crystals.

The method according to an aspect of the present disclosure may be implemented using a device, for example, described in EP 1 600 277 A1, by passing through three zones.
Zone 1: film shaping=calibration through a fixed roller nip including temperature compensation, as known from DE 10 2018 118 982 A1; in the process, the filling of the roller nip is monitored by a thermal camera.
Zone 2: in the case of polypropylene films, thermal modification is carried out in this zone; it is a zone for internal crystallite nucleus formation. The temperature control of the rollers is controlled using temperature sensors.
Zone 3: this involves cooling the film to a spooling temperature.

Each film is shaped in the temperature range that yields optimal film quality for the materials being processed, regardless of the subsequent processing zones.

A preset roller nip (determined from previous production runs) that, depending on the nozzle setting and roller temperature setting, still has to be adjusted again in most cases, even if it has been used in previous production runs. The consequences are different heat transfer from the film to the roller, and different stress and shrinkage values.

By way of the temperature compensation according to an aspect of the present disclosure, the roller nip remains constant even when the roller temperatures have to be corrected. This results in proportions as known in the manufacture of profiles and pipes, which are produced using fixed dies.

The above-described monitoring of the roller nip filling using a camera has two effects:
The cooling and thus the crystalline structure of the film, remain the same. This has a positive effect on the film tolerances. They decrease, for example from +/−0.02 mm to +/−0.005 mm for a 1 mm film, leading to a reduction in materials of around 0.5% to 1.5%.
Zone 2 (thermal modification) is adjusted to the film temperature that is optimal for, e.g., crystal nucleus formation, by means of two temperature sensors.

The purpose of the downstream cooling zone is to produce rapid cooling and thus fewer and smaller crystalline regions.

By splitting film manufacture into the three zones, not only is crystal formation minimized, but also few, or even no, supercrystalline structures are produced, e.g., spheroliths, which have a considerable negative impact on the further processing in thermoforming, by contrast with PP films which have been produced using a three-roller calender.

A significant effect is that today's standard processing temperatures of 148° C. to 152° C. can be reduced to the ranges of 128° C. to 138° C. This prevents new crystallites from forming when the film is heated, which have an adverse effect on the wall thickness in the finished product.

Zone 2 (thermal modification) yields the maximum number of crystallization nuclei and thus forms the basis for a higher degree of crystallization in the finished product; in conjunction with the optimal wall thickness, this leads to a considerable improvement in mechanical stability under load, e.g. the top load. Where the stability under load is predetermined, it is obtained while using less material. Depending on the geometry of the finished product, the reduction in material is between 5 and 10%.

The novel method offers the potential for material reductions of between 6.5% and 11.5% compared with the methods in the current state of the art.

Owing to the reduction in crystallinity and the lack of crystalline superstructures, fillers can be added in this method without bubbles forming during the subsequent thermoforming process; these bubbles diminish the mechanical properties of the finished product to such an extent that the positive effect of the admixture of fillers (greater rigidity in the finished product) is lost in its entirety.

The above-described method for manufacturing films for further processing in stretching systems or thermoforming systems can also be used in inline systems.

The same advantages in the end product are achieved. Some multi-touch systems are already used in large thermoforming systems and can be modified using the above-described modifications to this method.

There are four possible solutions for preventing sag in the thermoforming system:
1. one or two 3-10% outer layers having a nucleated material is/are used, or
2. the first two shaping rollers are run in the temperature range in which a 3-10% layer thickness is crystallized; sufficient strength in the film is thus produced at the low thermoforming temperatures, minimizing film sag, or
3. one or two outer layers of random PP copolymer are used, or
4. a third laminating film having a special sealing layer (to lower the sealing temperature for sealing finished products) is combined with a second outer layer of nucleated homo PP or a random PP copolymer.

According to an aspect of the present disclosure, a method is carried out using a calender that can additionally calibrate the film in the downstream rollers. The method and device are described in DE 10 2001 003 604 A1.

The spacing between the rollers is adjustable and can thus be set to different calibration nips. All the rollers can be moved into different positions. A plastics composition is introduced into the nip between the main rollers via a slotted nozzle and is precalibrated in a first step. The film goes through the next calibration nip between a main roller and the first downstream roller, and through the calibration nips between the rollers.

The spacings between these rollers, and thus the calibration nip produced, are selected such that the film is deformed in each nip such that a film of uniform quality is produced once it has passed through all the calibration nips.

Adjustment elements are arranged at the side next to the rollers and can change the position of the rollers with respect to one another. Since they are each arranged on both sides of each roller, each roller can be changed not only individually but also in terms of the angle relative to the adjacent roller.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for manufacturing a film made of a semi-crystalline plastics material, the method comprising:
a) shaping the film using a calender in which a melt coming from a slotted nozzle is introduced into a nip between two cooling or calibrating rollers, the film being calendered between the two cooling or calibrating rollers, the film being cooled in a cooling section comprising roller pairs arranged one after the other;
b) changing a film temperature by changing a temperature of downstream rollers, thereby achieving a maximum number of crystallization nuclei, the film temperature being detected using sensors; and
c) cooling the film down further to a film temperature that allows the film to be spooled,
wherein the temperature of the film being kept in a defined temperature range between 128° C. and 138° C. in step b), thereby preventing the automatic formation of further crystals.

2. The method according to claim 1, wherein polypropylene is used as the semi-crystalline plastics material.

3. The method according to claim 1, wherein the film is additionally calibrated in the downstream rollers, the position of the downstream rollers with respect to one another being changed by adjustment elements, as a result of which the prevailing roller nip between each roller pair is changed.

4. The method according to claim 1, the method further comprising adding fillers.

5. The method according to claim 1, wherein the method is executed in a stretching system or a thermoforming system in an inline system.

6. A device for carrying out the method according to claim 1, the device comprising the calender in which the film is configured to be additionally calibrated between the downstream roller pairs, and adjustment elements, by which, a position of the rollers with respect to one another are configured to be changed.

7. The device according to claim 6, the device further comprising a camera zone 1, the camera being configured to monitor a filling of the roller nips.

8. The device according to claim 6, the device further comprising temperature sensors zone 2, the temperature sensors being configured to measure the film temperature.
